(19) United States
(12) Patent Application Publication
(10) Pub. No.: US 2009/0201412 A1
(43) Pub. Date: Aug. 13, 2009

(54) Outdoor Camera Cage

(76) Inventor: Robert Merle Ament, JR., Bradford, PA (US)

Correspondence Address: Joseph F. Gula, III, 120 West Tenth Street, Erie, PA, 16501, US

(21) Appl. No.: 12/027,366

(22) Filed: Feb. 7, 2008

(51) Int. Cl. H04N 5/225

(52) U.S. Cl. 348/373

(57) ABSTRACT

An outdoor camera cage having a first, second, third and fourth sides and a bottom forming a rectangular box. The cage has a top cover hinged to the top of the rear side of the rectangular box to allow a camera to be inserted therein. The top cover contains four edges with two long cross bars and two short cross bars attached to the edges to allow the cross bars to move along the length of the edges. Once a camera is inserted into the cage, the camera is secured to the cage, the cover is closed and secured, the wire mesh is cut out around the camera lens and the entire apparatus is secured outdoors.

### CROSS-REFERENCE TO RELATED APPLICATIONS

Not Applicable

### FEDERALLY SPONSORED RESEARCH

Not Applicable

### BACKGROUND

This invention relates to a cage device designed to protect cameras from animals in the wild.

### SUMMARY

Hunters as well as other outdoor enthusiasts, in their efforts to ascertain the extent of wildlife in a particular area, will often setup a camera to do so. A camera will take pictures of a wildlife area at defined intervals, via a motion sensor, continuous video or timer. However, by simply mounting a camera in the wild one will frequently find that the wildlife will attack and destroy such cameras. Thus, the present invention is directed to a protective apparatus to protect cameras from wildlife attacks is necessary as disclosed herein.

### BRIEF DESCRIPTION OF THE DRAWINGS

These and other features, aspects and advantages of the present invention will become better understood with regard to the following description, appended claims, and accompanying drawings where:

FIG. 1 illustrates a perspective view of the apparatus with the cover partially opened.

FIG. 2 illustrates a top perspective view of the cover from above showing the two long and two short cross bars under the wire mesh.

FIG. 3 illustrates a side elevation view of the apparatus with the cover closed from the side of one of the long sides.

FIG. 4 illustrates a side elevation view of the apparatus with the cover closed from the side of one of the short sides.

FIG. 5 illustrates a perspective view of a top cover cross bar.

### DESCRIPTION

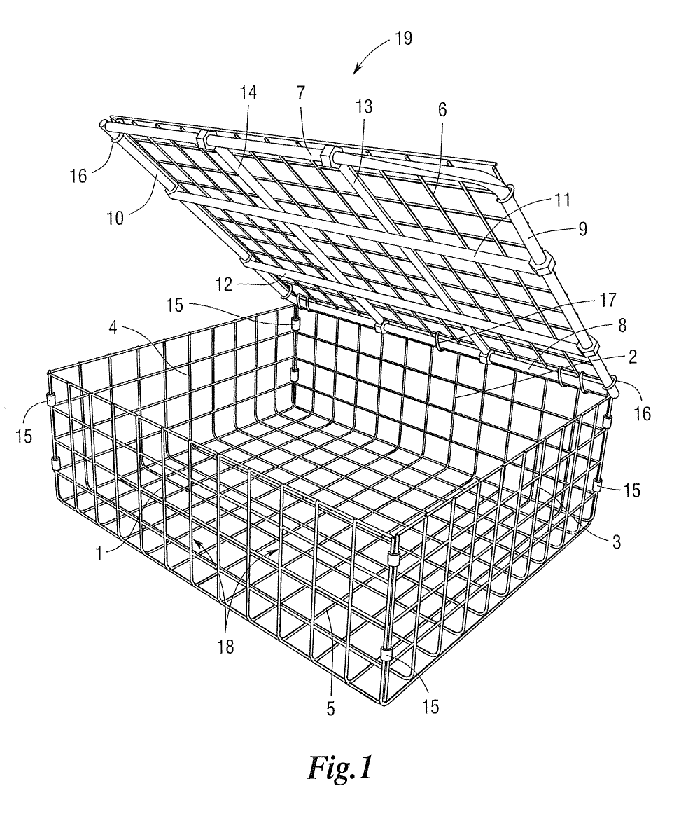

As shown in FIG. 1, an apparatus 19 is formed by creating a rectangular box composed of wire mesh 18 or other suitable material. Apparatus 19 has a base 5 and first, second, third and fourth sides, 1, 2, 3 and 4 formed from a single piece of wire mesh 18 or other suitable material. Sides 1 and 3 are affixed with clasps 15 or other means for fastening. Sides 2 and 3 are affixed with clasps 15 or other means for fastening. Sides 2 and 4 are affixed with clasps 15 or other means for fastening. Sides 1 and 4 are affixed with clasps 15 or other means for fastening.

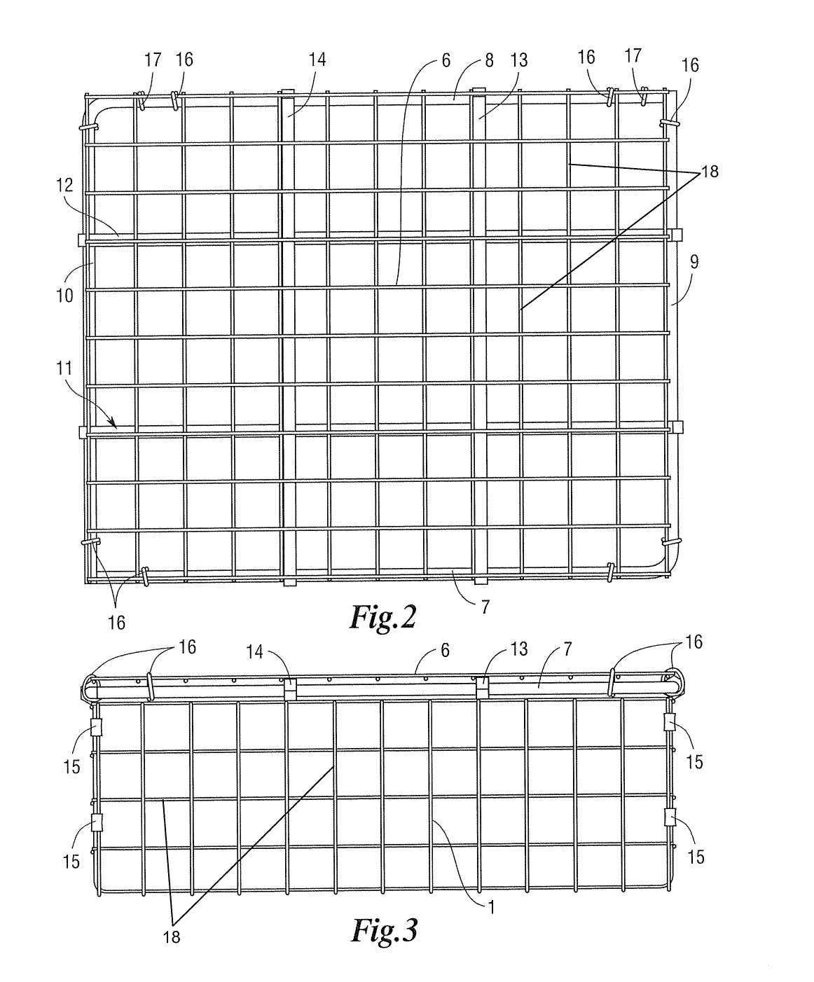

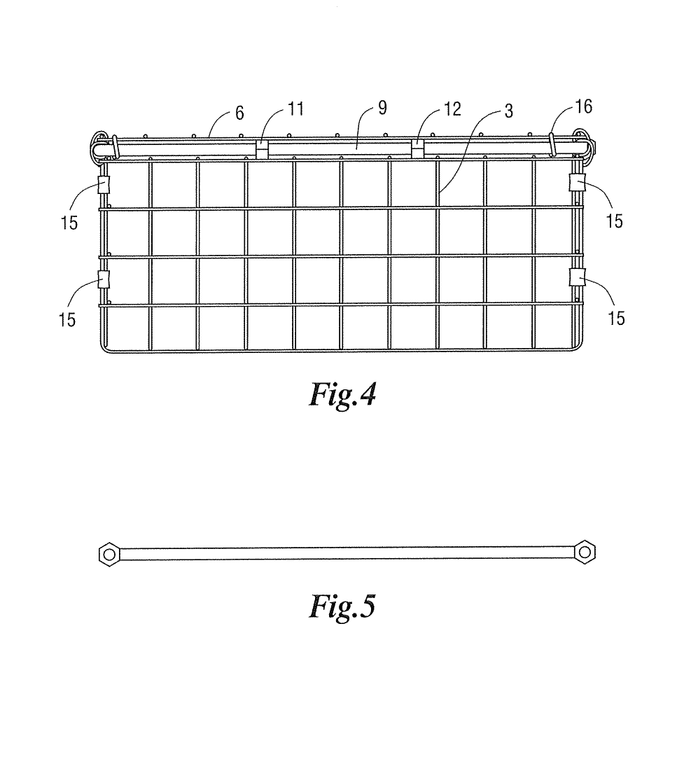

The cover 6 shown in FIG. 2 shows a metallic bar support bent to form the front 7, back 8 and two sides 9 and 10 to form a rectangle affixed to wire mesh 18 by clasps 15 or other means for fastening.

As shown in FIG. 5., the cross bars of cover 6 are formed by a tubular bar with an opening at the ends to allow for movement on the tubular bars of structures 7, 8, 9 and 10 from FIG. 2.

FIG. 2 further shows the long tubular cross bars 11 and 12 attached under the wire mesh 18 to the support bar sides 9 and 10 by means to allow bars 11 and 12 to move along the length of sides 9 and 10.

FIG. 2 further shows the short tubular cross bars 13 and 14 attached under the wire mesh 18 to the support bar sides 7 and 8 by means to allow bars 13 and 14 to move along the length of sides 7 and 8.

The cover 6 shown in FIG. 1 is affixed by clasps 17 or other means for fastening to the highest elevation of the wire mesh 18 forming side 2.

The manner of use of the camera cage 19 is to place a camera-type device into the cage 19 such that the camera's lens is facing the cover 6. The long bars 11 and 12 and the short bars 13 and 14 can be manipulated manually to surround the lens of the camera. The camera is then fastened to the cage 19 by means of a standard elastic loop or strap or equivalent closure means, not shown. Once the camera is placed and fastened to the apparatus, the cover 6 can be locked in its closed position by means of a standard elastic loop or strap or equivalent means, not shown. Once the cover 6 is locked in its closed position, the wire mesh 18 directly in front of the camera lens can be removed with wire cutters or equivalent means, not shown.

After the camera has been secured to the camera cage 19, the cage can be affixed to a tree or other outdoor formation by a standard elastic look or strap or equivalent closure means, not shown.

From the description above, a number of advantages of the camera cage become evident:

(a) protection from animals in the wild,

(b) a sturdy structure to assure the camera stays in place and

(c) protection from leaves and branches from falling and damaging the camera.

The reader's attention is directed to all papers and documents which are filed concurrently with this specification and which are open to public inspection with this specification, and the contents of all such papers and documents are incorporated herein by reference. All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specific function, or “step for” performing a specific function, is not to be interpreted as a “means” or “step” clause as specified in 35 U.S.C.§112 para. 6. In particular, the use of “step of” in the claims herein is not intended to invoke the provisions of 35 U.S.C.§112 para. 6.

I claim:

1. An apparatus for protecting a device comprising:
vertically deposed first, second, third and fourth sides each having the same height, a length, a top edge and a bottom edge, said first and third sides having the same length and said second and fourth sides having the same length, said bottom edges of said first, second, third and fourth sides when joined together forming the dimensions of a rectangle;
a base having the same dimensions as said rectangle, said base attached to said bottom edges of said first, second, third and fourth sides;
said top edges of said first, second, third and fourth sides forming a level being the height of said rectangle;
a top cover attached to a top edge of one of said sides, said cover having the same dimensions as the dimensions of said rectangle, said cover adapted to open and close;
means for fastening said cover to the top edge of the first side;
said sides and said base are formed of wire mesh materials;
said cover is formed from an inflexible tubular material having a first long bar and a second long bar attached to a first short bar and a second short bar to form the dimensions of a rectangle, a third and fourth short bars adapted to move along the length of the long bars and a third and fourth long bars adapted to move along the length of the short bars and said cover is covered with said wire mesh material;
whereby a device can be inserted into said apparatus;
means for fastening a device to the interior of the apparatus;
means for fastening the apparatus to an outdoor object such as a tree.

2. An apparatus of claim 1 whereby said wire mesh material is comprised of galvanized steel.

3. An apparatus of claim 1 whereby said inflexible tubular material is comprised of galvanized steel.
